(19) United States
(12) Patent Application Publication
(10) Pub. No.: US 2016/0114756 A1
(43) Pub. Date: Apr. 28, 2016

(54) VEHICLE SIDE AIRBAG DEVICE

(71) Applicant: TOYOTA JIDOSHA KABUSHIKI KAISHA, Toyota-shi (JP)

(72) Inventor: Yusuke FUJIWARA, Toyota-shi (JP)

(21) Appl. No.: 14/881,668

(22) Filed: Oct. 13, 2015

(30) Foreign Application Priority Data
Oct. 22, 2014 (JP) 2014-215404

(51) Int. Cl. B60R 21/231; B60R 21/233

(52) U.S. Cl. CPC B60R 21/23138; B60R 21/233; B60R 2021/0006

(57) ABSTRACT

A vehicle side airbag device that comprises: an inflator that is provided to a side section at a vehicle width direction outside of a seatback of a vehicle seat, and that operates to generate gas in a case in which a vehicle side-on collision is detected or predicted; and an airbag in which gas from the inflator housed inside a rear bag section is supplied into a front bag section through an inner vent hole, the front and rear bag sections inflate and deploy, the front bag section restrains at least a front portion of the chest of an occupant, the rear bag section restrains at least a shoulder region and a rear portion of the chest of the occupant, and an outer vent hole for emitting gas inside the rear bag section to the outside is formed to an upper edge portion of the rear bag section.

### CROSS-REFERENCE TO RELATED APPLICATION

This application is based on and claims priority under 35 USC 119 from Japanese Patent Application No. 2014-215404 filed on Oct. 22, 2014, which is incorporated by reference herein.

### BACKGROUND

1. Technical Field

The present disclosure relates to a vehicle side airbag device.

2. Related Art

In a vehicle side airbag device described in Japanese Patent Application Laid-Open (JP-A) No. 2014-141159, a side airbag is partitioned into a front side bag section (front bag section) that restrains front portions of the chest and abdominal region, a rear side bag section (rear bag section) that restrains the shoulder region and rear portions of the chest and abdominal region and a lower side bag section (lower bag section) that restrains the lumbar region, of an occupant. An inflator and a flow-regulating cloth are provided inside the rear bag section. Gas ejected from the inflator is ejected into the rear bag section from an upper end opening of the flow-regulating cloth, and ejected into the lower bag section from a lower end opening of the flow-regulating cloth. Some of the gas ejected into the rear bag section is supplied into the front bag section through a communication hole (inner vent hole) formed to a partitioning section between the front bag section and the rear bag section.

In the side airbag, the rear bag section with the inflator provided inside inflates and deploys at an earlier stage and a higher pressure than the front bag section. Thus the shoulder region and the rear portions of the chest and abdominal region, that have a relatively high load resistance, are restrained at an early stage by the rear bag section, while the front portions of the chest and abdominal region, that have a relatively low load resistance, are gently restrained by the front bag section

In vehicle side airbag devices such as that described above, after the inflator has finished ejecting gas, gas inside the higher pressure rear bag section flows (is emitted) into the front bag section through the inner vent hole, such that the internal pressure of the rear bag section gradually falls. The load from the rear bag section borne by the chest at a later restraint stage is thereby reduced. However, in cases in which the occupant is a woman with a small build, for example, the load resistance of the chest is lower than that of a man, for example, such that there is possibility that the load on the chest needs to be further reduced.

In consideration of the above circumstances, an object of the present disclosure is to obtain a vehicle side airbag device that contributes to improving chest protection performance at a rear bag section.

### SUMMARY OF INVENTION

A vehicle side airbag device of a first aspect includes: an inflator that is provided to a side section at a vehicle width direction outside of a seatback of a vehicle seat, and that operates to generate gas when a vehicle side-on collision is detected or predicted; and an airbag in which gas from the inflator housed inside a rear bag section is supplied into a front bag section through an inner vent hole, the front and rear bag sections inflate and deploy, the front bag section restrains at least a front portion of the chest of an occupant, the rear bag section restrains at least a shoulder region and a rear portion of the chest of the occupant, and an outer vent hole for emitting gas inside the rear bag section to the outside is formed to an upper edge portion or a rear edge portion of the rear bag section.

In the first aspect, the inflator operates in the event of a side-on collision of the vehicle, for example, the inflator generates gas inside the rear bag section of the airbag, and some of the gas generated inside the rear bag section is supplied into the front bag section through the inner vent hole. Each bag section, namely, the airbag, thereby inflates and deploys, at least the front portion of the chest of the occupant is restrained by the front bag section, and at least the shoulder region and the rear portion of the chest are restrained by the rear bag section.

During inflation and deployment, the rear bag section with the inflator housed inside inflates and deploys at an earlier stage and at a higher pressure than the front bag section. Gas inside the rear bag section is supplied (emitted) into the front bag section through the inner vent hole, and is emitted to the airbag exterior through the outer vent hole formed to the upper edge portion or the rear edge portion of the rear bag section. Forming the outer vent hole to the upper edge portion or the rear edge portion of the rear bag section enables blocking of the outer vent hole by the shoulder region of the occupant, and blocking of the outer vent hole due to interference with a vehicle body side section, to be prevented or suppressed in a side-on collision in which the occupant moves diagonally toward the front under inertia. This enables gas inside the rear bag section to be stably emitted from the two paths described above, thereby enabling the internal pressure of the rear bag section to be effectively reduced. Thus even when the chest of the occupant has a low load resistance, the load to the chest can be reduced, thereby contributing to improving chest protection performance by the rear bag section.

A vehicle side airbag device of a second aspect is the first aspect, wherein the outer vent hole is formed to the upper end portion of the rear bag section, faces a vehicle rear side in an inflated and deployed state of the airbag and is formed so as to be offset to the vehicle width direction outside of the seatback.

In the second aspect, the outer vent hole formed to the upper edge portion of the rear bag section is formed as described above, thereby enabling gas inside the rear bag section to be emitted to the vehicle rear side without interference from the seatback.

A vehicle side airbag device of a third aspect is the second aspect, wherein a projection portion that projects toward a vehicle upper side in the inflated and deployed state is formed to the upper edge portion of the rear bag section, and the outer vent hole is formed to a rear edge portion of the projection portion.

In the third aspect, the outer vent hole is formed to the rear edge portion of the projection portion as described above, thereby enabling the outer vent hole that faces the vehicle rear side in the inflated and deployed state of the airbag to be set at the upper edge portion of the rear bag section using a simple configuration.

A vehicle side airbag device of a fourth aspect is the first aspect, wherein the outer vent hole is formed to the upper end portion of the rear bag section, and is configured by an unstitched portion formed by partially omitting an outer peripheral stitch section at which outer peripheral edge portions of a base cloth of the airbag are stitched together, or by an elongated hole formed running along the outer peripheral stitch section.

In the fourth aspect, the outer vent hole has either of the configurations described above, thereby enabling the outer vent hole to be set at the upper edge portion of the rear bag section using a simple configuration. Note that the elongated hole includes a notch shaped hole (slit) with a thin width.

A vehicle side airbag device of a fifth aspect is the fourth aspect, in the inflated and deployed state, the elongated hole is positioned at the vehicle width direction inside or the vehicle width direction outside of the outer peripheral stitch section.

In the fifth aspect, in cases in which the outer vent hole configured by the elongated hole is positioned at the vehicle width direction inside of the outer peripheral stitch section of the airbag in the inflated and deployed state of the airbag, this contributes to an advantageous effect of preventing or suppressing the outer vent hole from becoming blocked due to interference with the vehicle body side section. In cases in which the outer vent hole configured by the elongated hole is positioned at the vehicle width direction outside of the outer peripheral stitch section of the airbag in the inflated and deployed state of the airbag, this contributes to an advantageous effect of preventing or suppressing gas emitted from the outer vent hole from having a detrimental effect on the occupant.

A vehicle side airbag device of a sixth aspect is any one of the first aspect to the fifth aspect, wherein: the airbag includes a lower bag section that is supplied with gas from the inflator and that inflates and that deploys below the front bag section and the rear bag section, and that restrains the lumbar region of the occupant; a front outer vent hole is formed to the front bag section; and a lower outer vent hole is formed to the lower bag section.

In the sixth aspect, gas inside the rear bag section is emitted into the front bag section through the inner vent hole, and emitted to the airbag exterior through the outer vent hole. Gas inside the front bag section and inside the lower bag section is emitted to the airbag exterior through the front outer vent hole and the lower outer vent hole. Gas inside each of the bag sections is thereby separately emitted to the airbag exterior, thereby enabling the internal pressure of each bag section to be suitably controlled.

### BRIEF DESCRIPTION OF DRAWINGS

FIG. 1 is a schematic side view of a vehicle seat configured applied with a vehicle side airbag device according to a first exemplary embodiment, illustrating an inflated and deployed state of a side airbag;

FIG. 2 is a front view of a portion in FIG. 1 viewed from the vehicle front side;

FIG. 3 is a slightly enlarged side view of the side airbag illustrated in FIG. 1;

FIG. 4 is a line graph illustrating a relationship between the internal pressure of each bag section provided to the side airbag, and a duration of time since an inflator has actuated;

FIG. 5 is a side view corresponding to FIG. 3, illustrating an inflated and deployed state of a side airbag in a vehicle side airbag device according to a second exemplary embodiment of the present invention;

FIG. 6 is an end-on view of the side airbag, illustrating a state viewed from the arrow A direction in FIG. 5;

FIG. 7 is an end-on view corresponding to FIG. 6, illustrating an inflated and deployed state of a side airbag in a vehicle side airbag device according to a third exemplary embodiment of the present invention;

FIG. 8 is a cross-section taken along line F8-F8 in FIG. 7;

FIG. 9 is an end-on view corresponding to FIG. 6, illustrating an inflated and deployed state of a side airbag in a vehicle side airbag device according to a fourth exemplary embodiment of the present invention;

FIG. 10 is a cross-section taken along line F10-F10 in FIG. 9;

FIG. 11 is an end-on view corresponding to FIG. 6, illustrating an inflated and deployed state of a side airbag in a vehicle side airbag device according to a fifth exemplary embodiment of the present invention;

FIG. 12 is a side view corresponding to FIG. 3, illustrating an inflated and deployed state of a side airbag in a vehicle side airbag device according to a sixth exemplary embodiment of the present invention;

FIG. 13 is a side view corresponding to FIG. 3, illustrating an inflated and deployed state of a side airbag in a vehicle side airbag device according to seventh exemplary embodiment of the present invention; and

FIG. 14 is a cross section taken along line F14-F14 in FIG. 13.

### DESCRIPTION OF EMBODIMENTS

### First Exemplary Embodiment

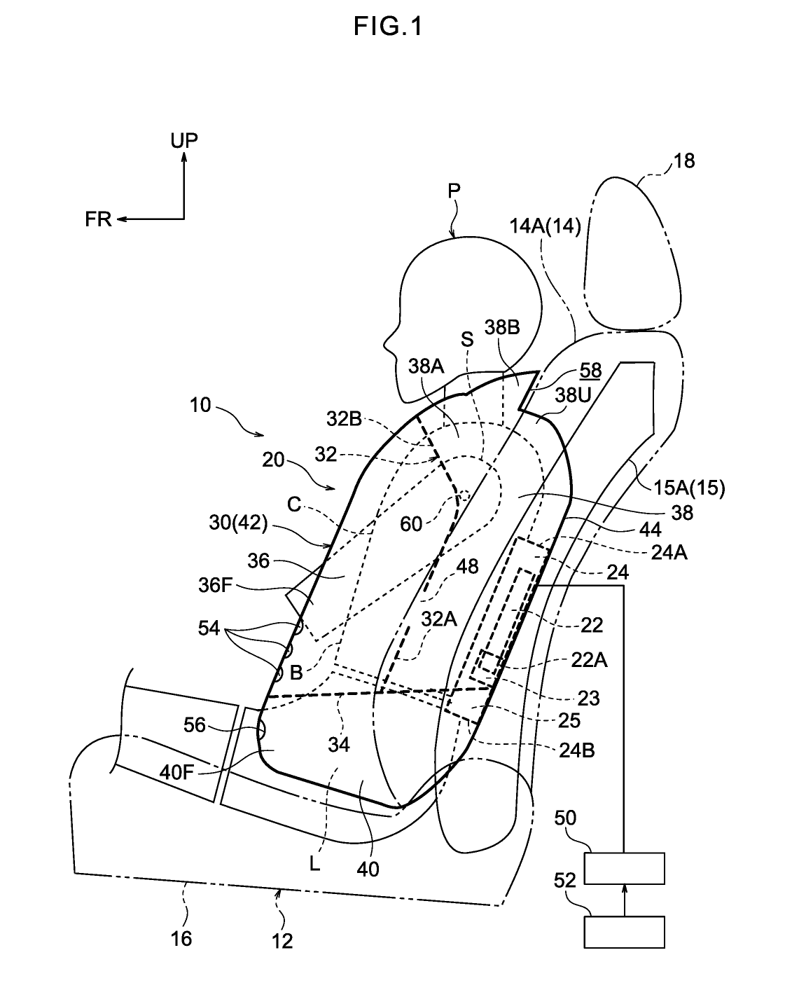

Explanation follows regarding a vehicle side airbag device 10 according to a first exemplary embodiment of the present invention, with reference to FIG. 1 to FIG. 4. Note that in each of the drawings, the arrow FR, the arrow UP, and the arrow OUT respectively indicate the front direction (the direction of travel), the upper direction, and the vehicle width outside direction. In the following explanation, unless specifically stated otherwise, explanation using simply the front-rear and up-down directions refers to the front-rear of the vehicle front-rear direction and the up-down of the vehicle up-down direction.

Configuration

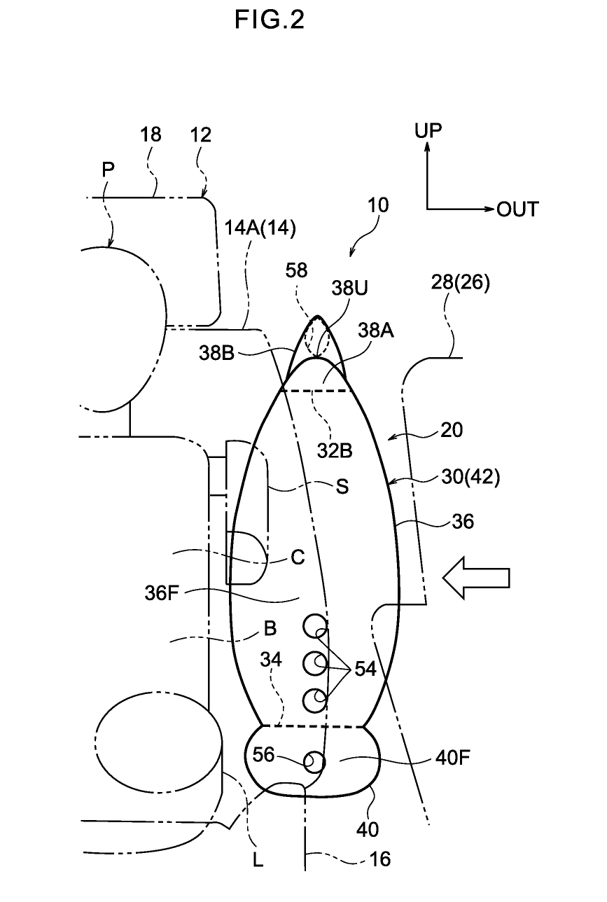

As illustrated in FIG. 1, the side airbag device 10 according to the first exemplary embodiment is installed to a door-side side support section 14A (a vehicle width direction outside side section, a side section at the side of a side door 26 illustrated in FIG. 2) of a seatback 14 of a vehicle seat 12. The seatback 14 is reclinably coupled to a rear end section of a seat cushion 16, and an upper end section of the seatback 14 is coupled to a headrest 18.

Note that in the present exemplary embodiment, the front-rear direction, left-right direction (width direction), and up-down direction of the vehicle seat 12 are aligned with the front-rear direction, left-right direction (width direction), and up-down direction of the vehicle. In FIG. 1, a crash test dummy P used in side-on collision testing is illustrated seated in the vehicle seat 12 instead of an actual occupant. The dummy P is, for example, an SID-2S (a 5^{th} percentile female). The dummy P is seated in a standard seated posture specified in collision testing methods. A front-rear position of the seat cushion 16 with respect to the vehicle, and a slope position (slope angle) of the seatback 14 with respect to the seat cushion 16, are adjusted to reference set positions corresponding to the seated posture. In order to facilitate understanding of the explanation, the dummy P is hereafter referred to as “occupant P”.

As illustrated in FIG. 1 to FIG. 3, the side airbag device 10 includes a side airbag 20 serving as an airbag, and an inflator 22 and a diffuser 24 provided inside the side airbag 20. The side airbag 20 configures a module together with the inflator 22 and the diffuser 24, and, in a folded state, is stored inside the door-side side support section 14A (hereafter referred to as “side section 14A”). The side airbag 20 inflates and deploys between the occupant P and the side door 26 (a vehicle body side section, see FIG. 2) due to pressure from gas generated by the inflator 22. A seatback pad and a seat cover installed to the side section 14A are configured so as to rupture under inflation pressure of the side airbag 20 during inflation and deployment. Note that in the explanation below, unless specifically stated otherwise, front-rear and up-down directions of the side airbag 20 refer to directions of the side airbag 20 in an inflated and deployed state, and are substantially aligned with the front-rear and up-down directions of the seatback 14.

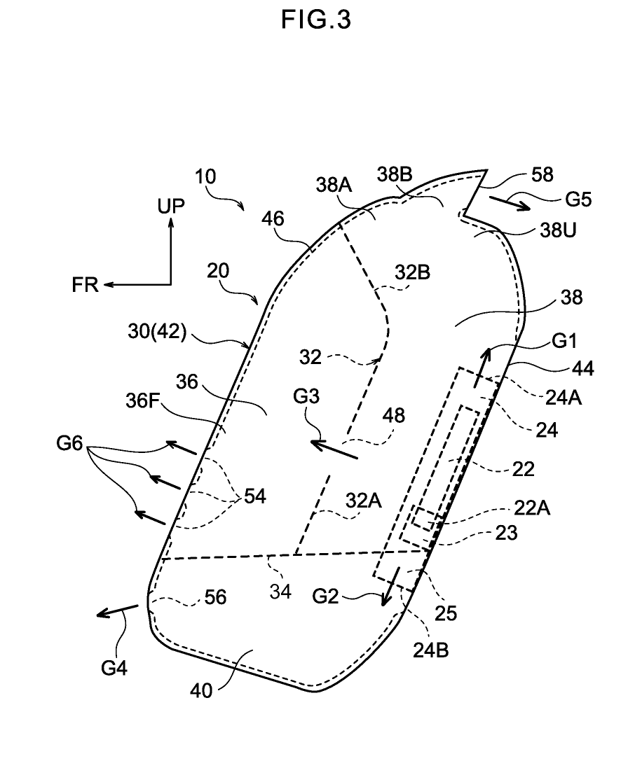

The side airbag 20 is what is referred to as a triple chamber side airbag, and a bag body 30 is configured partitioned into a front bag section 36, a rear bag section 38, and a lower bag section 40, by a front-rear partitioning section 32 and an upper-lower partitioning section 34. The bag body 30 is formed from a single base cloth 42, cut out of a cloth material made of nylon thread or polyester thread, for example. The base cloth 42 is folded into two along a fold line 44, and formed in a bag shape by stitching together outer peripheral edge portions at an outer peripheral stitch section 46 of one side portion and the other side portion on each side of the fold line 44 (see FIG. 3).

The front-rear partitioning section 32 and the upper-lower partitioning section 34 are tethers disposed inside the bag body 30, and are each formed, for example, by cutting out a cloth material similar to the base cloth 42 of the bag body 30 in an elongated belt shape. The front-rear partitioning section 32 and the upper-lower partitioning section 34 are each stitched to the one side portion of the base cloth 42 of the bag body 30 at one long side edge portion, and stitched to the other side portion of the base cloth 42 of the bag body 30 at the other long side edge portion. The upper-lower partitioning section 34 is set so as to extend along the vehicle front-rear direction. The front-rear partitioning section 32 is configured by an upright partitioning portion 32A extending along the up-down direction of the seatback 14, and a sloped partitioning section 32B extending from an upper end of the upright partitioning portion 32A diagonally toward the upper front of the seatback 14. The upright partitioning portion 32A is formed with an inner vent hole 48 (a communication opening) that places the inside of the front bag section 36 and the inside of the rear bag section 38 in communication with each other.

When viewed in the inflated and deployed state in the side view illustrated in FIG. 1, the side airbag 20 is formed so as to form an elongated, substantially elliptical shape along the up-down direction of the seatback 14, and is set to a size capable of restraining the shoulder region S, the chest C, the abdominal region B, and the lumbar region L of the occupant P. In the inflated and deployed state, the front bag section 36 and the rear bag section 38 are aligned in the vehicle front-rear direction, and the lower bag section 40 is disposed at the lower side of the front bag section 36 and the rear bag section 38. An upper portion of the rear bag section 38 that is partitioned off from the front bag section 36 by the sloped partitioning section 32B is provided with a front extension portion 38A, and the front extension portion 38A inflates and deploys toward the upper side of the front bag section 36. The front extension portion 38A is set in order to restrain the shoulder region S of the occupant P.

Note that the manufacturing method of the side airbag 20 is not limited to that described above, and may be changed as appropriate. The side airbag 20 may be configured, for example, manufactured by a manufacturing method described in JP-A No. 2014-31096. The front-rear partitioning section 32 and the upper-lower partitioning section 34 are not limited to being configured by tethers, and may each be configured by a stitched portion (seam) stitched to a base cloth of the bag body 30.

The inflator 22 and the diffuser 24 are housed at a rear end side of a lower portion inside the rear bag section 38. The diffuser 24 is a member referred to as a loop diffuser, an inner tube, a flow-regulating cloth or the like. The diffuser 24 is formed by a base cloth, formed by cutting out a cloth material similar to the base cloth of the side airbag 20 in a rectangular shape, and is stitched into a circular tube shape. The diffuser 24 is disposed oriented with its axial line direction along the height direction of the seatback 14. The diffuser 24 includes a function to distribute gas generated by the inflator 22 toward the top and bottom. A lower end portion of the diffuser 24 pierces through the upper-lower partitioning section 34 and projects into the lower bag section 40. This projecting portion configures a check valve 25.

The inflator 22 is a cylinder type gas generator, formed in a circular cylindrical shape. The inflator 22 is set with a slightly smaller axial line direction dimension than the diffuser 24, and is housed inside the diffuser 24 oriented with its axial line direction along the axial line direction of the diffuser 24. A pair of upper and lower stud bolts project out from outer peripheral portions of the inflator 22 toward the vehicle width direction outside. The stud bolts pierce through the base cloth of the side airbag 20, the base cloth of the diffuser 24, and a side frame 15A of a seatback frame 15, and nuts are screwed onto leading end sides of the stud bolts. The inflator 22 is thereby fastened and fixed (side face fastening) to the seatback frame 15 together with the side airbag 20 and the diffuser 24. Note that a configuration may be applied in which stud bolts projecting out from outer peripheral portions of the inflator 22 toward the vehicle rear side pierce through brackets fixed to the side frame 15A and are screwed together with nuts (back face fastening).

A lower end portion of the inflator 22 is inserted inside a deflector 23 formed in a circular cylindrical shape. The deflector 23 is fixed to the lower end portion of the inflator 22 by a means such as crimping, and covers a gas ejection portion 22A provided to the lower end portion of the inflator 22.

As illustrated in FIG. 1, the inflator 22 is electrically connected to a side collision ECU 50 mounted to the vehicle. A side collision sensor 52 that detects a side-on collision is electrically connected to the side collision ECU 50. The side collision ECU 50 is configured to operate (actuate) the inflator 22 when (the inevitability of) a side-on collision has been detected based on a signal from the side collision sensor 52. Note that, in cases in which a pre-crash sensor that predicts (forecasts) a side-on collision is electrically connected to the side collision ECU 50, the inflator 22 may be configured to be operated when the side collision ECU 50 has predicted a side-on collision based on a signal from the pre-crash sensor. Explanation follows regarding relevant portions of the present exemplary embodiment.

### Relevant Portions of Present Exemplary Embodiment

In the present exemplary embodiment, one or plural (three in this example) front outer vent holes 54 for emitting gas from inside the front bag section 36 are formed to a front edge portion 36F of the front bag section 36. The front outer vent holes 54 place the inside of the front bag section 36 and the outside of the side airbag 20 in communication with each other. One or plural (one in this example) lower outer vent hole 56 for emitting gas from inside the lower bag section 40 is formed to a front edge portion 40F of the lower bag section 40. The lower outer vent hole 56 places the inside of the lower bag section 40 and the outside of the side airbag 20 in communication with each other. In the present exemplary embodiment, the front outer vent holes 54 and the lower outer vent hole 56 are each configured by an unstitched portion formed where the outer peripheral stitch section 46 is partially omitted.

In the present exemplary embodiment, a projection portion 38B, projecting toward the vehicle upper side (the upper side of the seatback 14) in the inflated and deployed state of the side airbag 20 is formed to an upper edge portion 38U of the rear bag section 38. The projection portion 38B is formed such that a projection amount toward the upper side of the seatback 14 increases on progression toward the vehicle rear side, and is formed in a substantially triangular shape in seat side view. In the present exemplary embodiment, the projection portion 38B is formed by extending the base cloth of the bag body 30 toward the vehicle upper side, and is integrally formed to the bag body 30. Note that the projection portion 38B is not limited to being configured integrally formed to the base cloth of the bag body 30 as in the present exemplary embodiment, and the projection portion 38B may be formed by a piece of cloth that is a separate body to the bag body 30 being stitched to the bag body 30. Such cases enable, for example, yield of the base cloth to be improved.

A rear outer vent hole 58, serving as an outer vent hole for emitting gas from inside the rear bag section 38, is formed to a rear edge portion of the projection portion 38B. The rear outer vent hole 58 places the inside of the rear bag section 38 and the outside of the side airbag 20 in communication with each other. As illustrated in FIG. 3, the rear outer vent hole 58 is configured by an unstitched portion formed where the outer peripheral stitch section 46 is partially omitted, and is set so as to face the vehicle rear side (the vehicle rear and slightly diagonally downward in the present exemplary embodiment) in the inflated and deployed state. As illustrated in FIG. 1, in side view in the inflated and deployed state, the rear outer vent hole 58 is set so as to be positioned further toward the vehicle rear side than the center of the shoulder region S of the occupant P (the axial center of a bolt 60 provided to the shoulder region S of the dummy P in this example). As illustrated in FIG. 2, in the inflated and deployed state, the rear outer vent hole 58 and the projection portion 38B are formed offset to the vehicle width direction outside of the seatback 14.

In the present exemplary embodiment, an opening area of the rear outer vent hole 58 is set the same as or larger than an opening area of the lower outer vent hole 56. The opening area of the rear outer vent hole 58 is set smaller than a sum total area of the opening areas of the three front outer vent holes 54, and the sum total area of the opening areas of the three front outer vent holes 54 is set smaller than an opening area of the inner vent hole 48.

In the side airbag device 10 with the above configuration, gas ejected from the gas ejection portion 22A of the inflator 22 when the inflator 22 is operated (actuated) is ejected toward the top and bottom from an upper end opening and a lower end opening of the deflector 23. Distribution amounts of gas toward the top and bottom when this occurs can be adjusted by moving a fixing position of the deflector 23 to the inflator 22 up and down.

Gas ejected from the upper end opening of the deflector 23 is ejected from an upper end opening 24A of the diffuser 24 toward the upper portion inside the rear bag section 38 (see the arrow G1 in FIG. 3). Gas ejected from the lower end opening of the deflector 23 is ejected from a lower end opening 24B of the diffuser 24 into the lower bag section 40 (see the arrow G2 in FIG. 3). Gas ejected into the rear bag section 38 is supplied into the front bag section 36 through the inner vent hole 48 (see the arrow G3 in FIG. 3).

The front bag section 36, the rear bag section 38, and the lower bag section 40 (namely, the side airbag 20) thereby inflate and deploy between the occupant P and a door trim 28 of the side door 26. Thus front portions of the chest C and abdominal region B of the occupant P are restrained by the front bag section 36, and the shoulder region S and rear portions of the chest C and the abdominal region B of the occupant P are restrained by the rear bag section 38, and the lumbar region L of the occupant P is restrained by the lower bag section 40.

When the internal pressure of the lower bag section 40 reaches a predetermined value or above due to gas being ejected inside the lower bag section 40 from the lower end opening 24B of the diffuser 24, the check valve 25 configured by the lower end portion of the diffuser 24 is squashed by the internal pressure of the lower bag section 40. The flow of gas from inside the lower bag section 40 to inside the rear bag section 38 is thereby restricted, and gas inside the lower bag section 40 is emitted to the side airbag 20 exterior through the lower outer vent hole 56 (see the arrow G4 in FIG. 3).

Gas supplied inside the rear bag section 38 is supplied (emitted) into the front bag section 36 through the inner vent hole 48 (see the arrow G3 in FIG. 3), and is emitted to the side airbag 20 exterior through the rear outer vent hole 58 (see the arrow G5 in FIG. 3). Gas supplied into the front bag section 36 is emitted to the side airbag 20 exterior through the three front outer vent holes 54 (see the arrows G6 in FIG. 3).

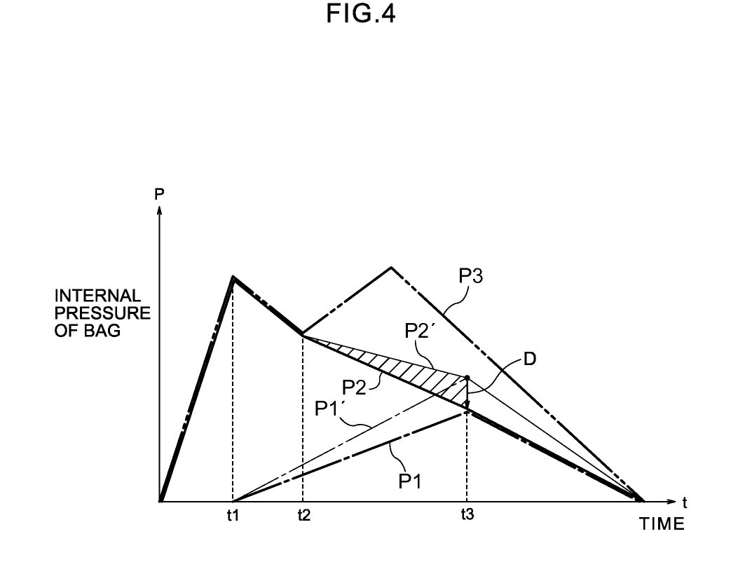

FIG. 4 is a line graph illustrating a relationship between time elapsed since the inflator 22 has actuated and the internal pressure of each of the bag sections 36, 38, 40. In FIG. 4, the internal pressure of the front bag section 36 is represented by the thick single-dotted dashed line P1, the internal pressure of the rear bag section 38 is represented by the thick solid line P2, and the internal pressure of the lower bag section 40 is represented by the thick double-dotted dashed line P3. In FIG. 4, the thin solid line P2′ represents the internal pressure of the rear bag section 38 when the rear outer vent hole 58 is not provided to the rear bag section 38, and the thin single-dotted dashed line P1′ represents the internal pressure of the front bag section 36 when the rear outer vent hole 58 is not provided to the rear bag section 38. In FIG. 4, t1 represents a point in time when the inflator 22 has finished ejecting gas, t2 represents a point in time when the check valve 25 operates (is squashed), and t3 represents a point in time when the internal pressure of the front bag section 36 and the internal pressure of the rear bag section 38 are the same. In the present exemplary embodiment, a period of time prior to t2 in FIG. 4 configures an “initial restraint stage”, and a period of time from t2 onward configures a “later restraint stage”.

As illustrated in FIG. 4, the internal pressures of the rear bag section 38 and the lower bag section 40 supplied directly with the gas G1, G2 from the diffuser 24 rise at an earlier stage and at a higher pressure than the internal pressure of the front bag section 36 supplied with the gas G3 through the inner vent hole 48. The internal pressure of the lower bag section 40 temporarily rises due to load from the occupant P after operation of the check valve 25, while the internal pressure of the rear bag section 38 continues to fall accompanying a rise in the internal pressure of the front bag section 36. The internal pressure of the rear bag section 38 and the internal pressure of the front bag section 36 are the same at the point in time t3 in FIG. 4. The internal pressures of the rear bag section 38 and the front bag section 36 then fall due to emission of the gas G5, G6 from the rear outer vent hole 58 and the three front outer vent holes 54. In the present exemplary embodiment, configuration is accordingly such that the internal pressure of the lower bag section 40 is higher than the internal pressure of the rear bag section 38, and the internal pressure of the rear bag section 38 is higher than the internal pressure of the front bag section 36 until the point in time t3 in FIG. 4. Although the internal pressure of the lower bag section 40 gradually falls due to emission of the gas G4 from the lower outer vent hole 56 after operation of the check valve 25, a high pressure state is maintained from the initial restraint stage to the later restraint stage.

Operation and Advantageous Effects

Explanation follows regarding operation and advantageous effects of the first exemplary embodiment.

In the side airbag device 10 with the above configuration, the inflator 22 is operated by the side collision ECU 50 when the side collision ECU 50 detects a side-on collision using a signal from the side collision sensor 52. Gas ejected from the inflator 22 is then supplied into the rear bag section 38 and into the lower bag section 40 from the upper end opening 24A and the lower end opening 24B of the diffuser 24, and some of the gas supplied into the rear bag section 38 is supplied into the front bag section 36 through the inner vent hole 48. Each of the bag sections 36, 38, 40, namely, the side airbag 20, thereby inflate and deploy, the front portions of the chest C and abdominal region B of the occupant P are restrained by the front bag section 36, the shoulder region S and the rear portions of the chest C and abdominal region B are restrained by the rear bag section 38, and the lumbar region L is restrained by the lower bag section 40.

During inflation and deployment, the rear bag section 38 with the inflator 22 housed inside inflates and deploys at an earlier stage and at a higher pressure than the front bag section 36. This enables the shoulder region S and the rear portions of the chest C and abdominal region B to be restrained at an early stage by the higher pressure rear bag section 38, thereby enabling good early stage occupant restraint performance. In the later restraint stage, gas inside the rear bag section 38 is emitted into the front bag section 36 through the inner vent hole 48, and emitted to the side airbag 20 exterior through the rear outer vent hole 58 formed to the upper edge portion 38U of the rear bag section 38, and the internal pressure of the rear bag section 38 gradually falls.

Forming the rear outer vent hole 58 to the upper edge portion 38U of the rear bag section 38 enables blocking of the rear outer vent hole 58 by the shoulder region S, and blocking of the rear outer vent hole 58 due to interference from the side door 26, to be prevented or suppressed in the event of a side-on collision in which the occupant P moves diagonally toward the front under inertia. This enables gas inside the rear bag section 38 to be stably emitted from the two paths described above, thereby enabling the internal pressure of the rear bag section 38 to be effectively reduced in the later restraint stage. Namely, providing the rear outer vent hole 58 to the rear bag section 38 promotes a reduction in the internal pressure of the rear bag section 38 at the later restraint stage (see the arrow D in FIG. 4). Thus even when the occupant is a female with a small build and low load resistance at the chest, corresponding to an SID-2S, for example, the load to the chest can be reduced. This accordingly contributes to improving chest protection performance by the rear bag section 38.

Note that it would be conceivable to enlarge the opening area of the inner vent hole 48 to increase the flow rate of gas emitted into the front bag section 36 from inside the rear bag section 38 in order to effectively reduce the internal pressure of the rear bag section 38 at the later restraint stage. However, if the opening area of the inner vent hole 48 were enlarged, the flow rate of gas supplied into the front bag section 36 through the inner vent hole 48 during the initial inflation and deployment stage of the side airbag 20 would increase, and the internal pressure of the front bag section 36 would increase during the initial inflation and deployment stage. In such cases, for example, this would be detrimental to protection performance of an occupant positioned in an unsuitable position (out of position (OOP)) within an inflation and deployment region of the front bag section 36 (OOP performance). In this respect, the present exemplary embodiment also contributes to securing OOP performance, since the emission of gas from the rear bag section 38 can be secured by the rear outer vent hole 58, regardless of the opening area of the inner vent hole 48.

In the present exemplary embodiment, the rear outer vent hole 58 formed to the upper edge portion 38U of the rear bag section 38 faces the vehicle rear side, and is formed offset to the vehicle width direction outside of the seatback 14 in the inflated and deployed state of the side airbag 20. This enables gas inside the rear bag section 38 to be emitted to the vehicle rear side without interference from the seatback 14. This enables the gas emitted from the rear outer vent hole 58 to be prevented or suppressed from having a detrimental effect on the occupant P.

In the present exemplary embodiment, the projection portion 38B, projecting out to the vehicle upper side in the inflated and deployed state of the side airbag 20, is formed to the upper edge portion 38U of the rear bag section 38, and the rear outer vent hole 58 is formed to the rear edge portion of the projection portion 38B. This enables the rear outer vent hole 58 that faces the vehicle rear side in the inflated and deployed state of the side airbag 20 to be set at the upper edge portion 38U of the rear bag section 38 using a simple configuration.

In the present exemplary embodiment, gas inside the rear bag section 38 is emitted to the side airbag 20 exterior through the rear outer vent hole 58, and gas inside the front bag section 36 and inside the lower bag section 40 is also emitted to the side airbag 20 exterior through the front outer vent holes 54 and the lower outer vent hole 56. Separately emitting gas inside each of the bag sections 36, 38, 40 to the side airbag 20 exterior in this manner enables the internal pressure of each of the bag sections 36, 38, 40 to be suitably controlled. This enables the occupant P to be suitably restrained from the shoulder region S as far as the lumbar region L, using restraint force that corresponds to the load resistance of each region.

Explanation follows regarding other exemplary embodiments of the present invention. Note that configuration and operation that are basically the same as the first exemplary embodiment are appended with the same reference numerals as the first exemplary embodiment, and explanation thereof is omitted.

### Second Exemplary Embodiment

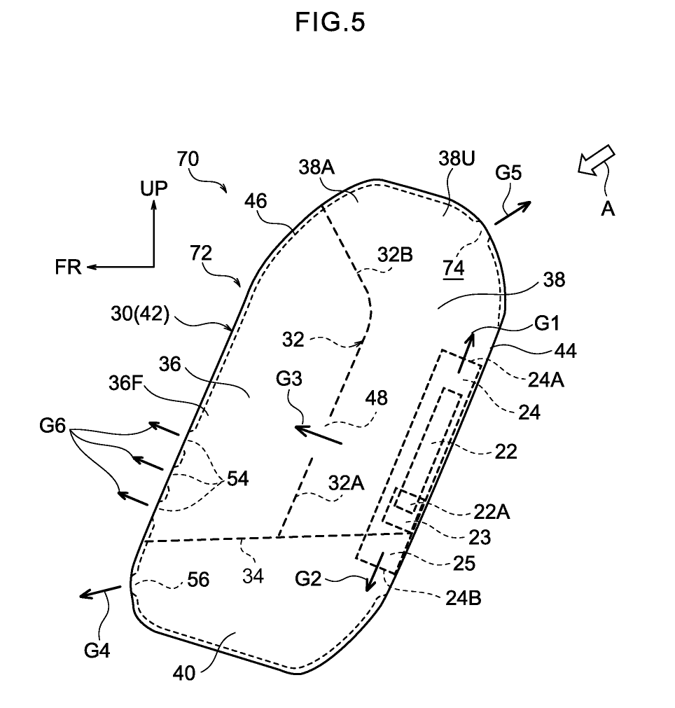

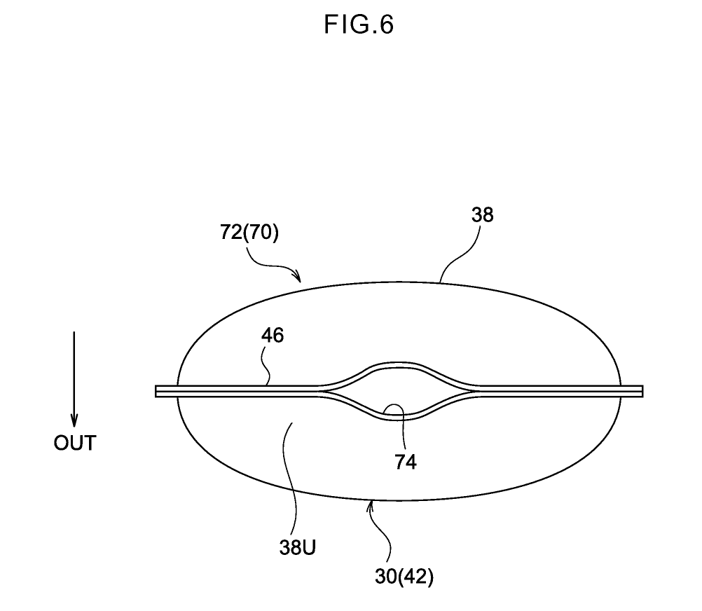

FIG. 5 is a side view corresponding to FIG. 3, illustrating an inflated and deployed state of a side airbag 72 in a vehicle side airbag device 70 according to a second exemplary embodiment of the present invention. FIG. 6 is an end-on view illustrating the side airbag 72 in a state viewed from the arrow A direction in FIG. 5. In the side airbag 72, the projection portion 38B according to the first exemplary embodiment is omitted, and a rear outer vent hole 74 that differs from the rear outer vent hole 58 according to the first exemplary embodiment is formed to the upper edge portion 38U of the rear bag section 38. Other configuration of the side airbag 72 is similar to that in the side airbag 20 according to the first exemplary embodiment.

The rear outer vent hole 74 is configured by an unstitched portion formed where the outer peripheral stitch section 46 is partially omitted (see FIG. 6). In the inflated and deployed state of the side airbag 72, the rear outer vent hole 74 is positioned further to the vehicle rear side than the center of the shoulder region S of the occupant P (the bolt 60), and set so as to open toward the vehicle upper side and the vehicle rear side. Configuration is thereby such that gas supplied into the rear bag section 38 is emitted diagonally toward the vehicle upper rear from the rear outer vent hole 74. The present exemplary embodiment enables the rear outer vent hole 74 to be set at the upper edge portion 38U of the rear bag section 38 using a simpler configuration than in the first exemplary embodiment. The present exemplary embodiment also enables gas emitted from the rear outer vent hole 74 to flow in a perpendicular, or substantially perpendicular, direction to the vehicle width direction, thereby enabling the gas to be prevented or suppressed from having a detrimental effect on the occupant P.

### Third Exemplary Embodiment

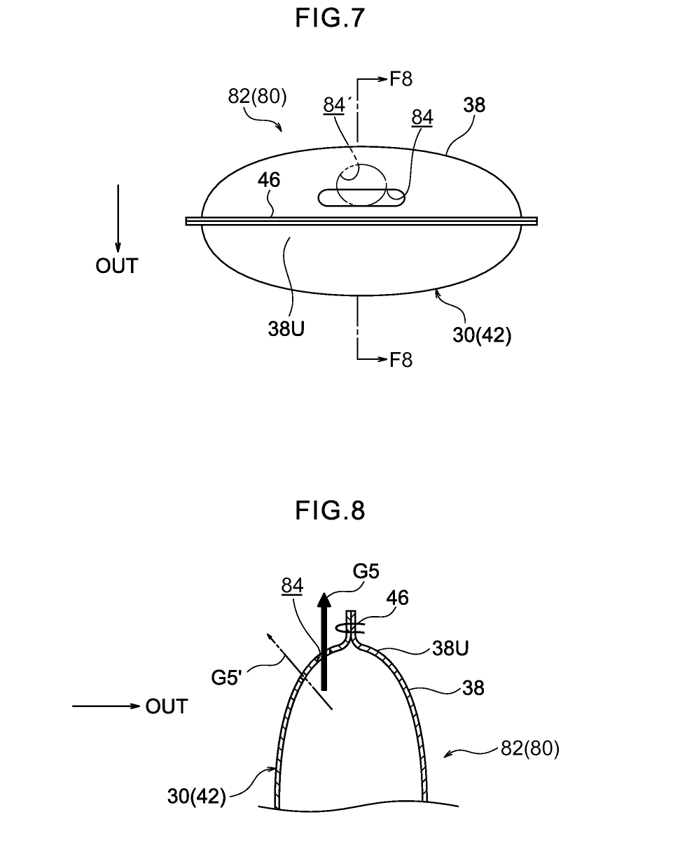

FIG. 7 is an end-on view corresponding to FIG. 6, illustrating an inflated and deployed state of a side airbag 82 in a vehicle side airbag device 80 according to a third exemplary embodiment of the present invention. FIG. 8 is a cross-section taken along line F8-F8 in FIG. 7. In the side airbag 82, a rear outer vent hole 84 is configured by an elongated hole, while other configuration is similar to that in the second exemplary embodiment. The rear outer vent hole 84 is formed running along the outer peripheral stitch section 46 of the side airbag 82 at the upper edge portion 38U of the rear bag section 38 (with a direction along the outer peripheral stitch section 46 as its length direction), and is provided so as to be positioned at the vehicle width direction inside of the outer peripheral stitch section 46 in the inflated and deployed state of the side airbag 82. The rear outer vent hole 84 is formed, for example, to the upper edge portion 38U of the rear bag section 38 in a region at a distance within a range, for example, from 5 mm to 10 mm from the outer peripheral stitch section 46.

The present exemplary embodiment also enables the rear outer vent hole 84 to be set at the upper edge portion 38U of the rear bag section 38 using a simpler configuration than in the first exemplary embodiment. Moreover, gas emitted from the rear outer vent hole 84 (see the arrow G5 in FIG. 8) can flow in a perpendicular, or substantially perpendicular, direction to the vehicle width direction, thereby enabling the gas G5 to be prevented or suppressed from having a detrimental effect on the occupant P. Namely, as illustrated by the double-dotted dashed line in FIG. 7, for example, if a similar opening area to that of the rear outer vent hole 84 were secured by a rear outer vent hole 84′ configured as a circular hole, gas emitted from the rear outer vent hole 84′ would flow toward the vehicle width direction inside (the occupant P side), as illustrated by the arrow G5′ in FIG. 8. However, the present exemplary embodiment enables this to be avoided.

### Fourth Exemplary Embodiment

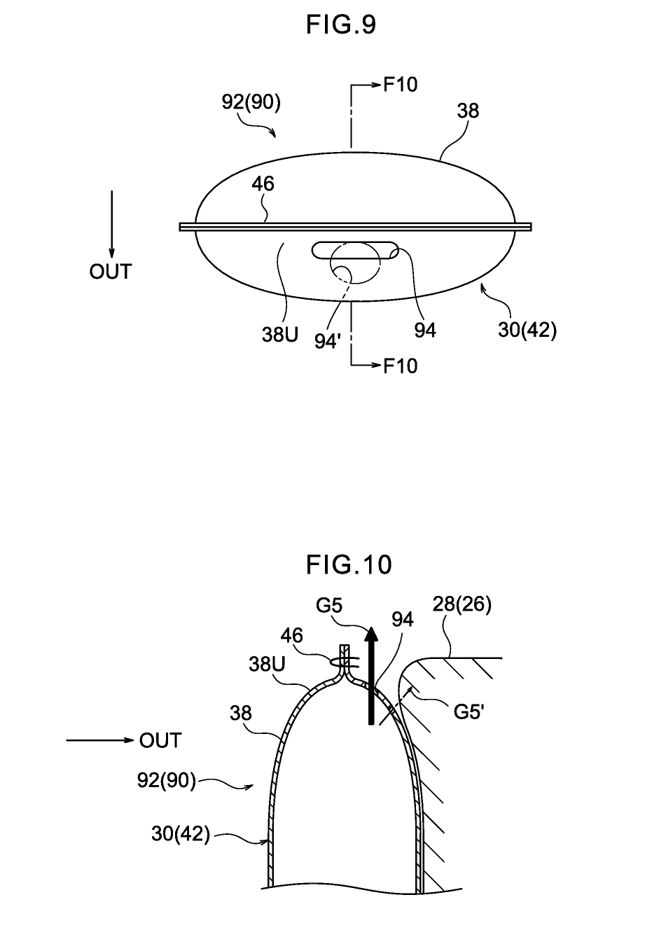

FIG. 9 is an end-on view corresponding to FIG. 6, illustrating an inflated and deployed state of a side airbag 92 in a vehicle side airbag device 90 according to a fourth exemplary embodiment of the present invention. FIG. 10 is a cross-section taken along line F10-F10 in FIG. 9. In the side airbag 92, a rear outer vent hole 94 is configured by an elongated hole running along the outer peripheral stitch section 46, similarly to that in the third exemplary embodiment. However, the rear outer vent hole 94 is provided so as to be positioned at the vehicle width direction outside of the outer peripheral stitch section 46 in the inflated and deployed state of the side airbag 82. The rear outer vent hole 94 is formed, for example, to the upper edge portion 38U of the rear bag section 38 in a region at a distance within a range, for example, from 5 mm to 10 mm from the outer peripheral stitch section 46, similarly to the rear outer vent hole 84 according to the third exemplary embodiment. Other configuration is similar to that in the third exemplary embodiment.

The present exemplary embodiment also enables the rear outer vent hole 94 to be set at the upper edge portion 38U of the rear bag section 38 using a simpler configuration than in the first exemplary embodiment. Moreover, gas emitted from the rear outer vent hole 94 (see the arrow G5 in FIG. 10) can flow in a perpendicular, or substantially perpendicular, direction to the vehicle width direction, thereby enabling a configuration that is not detrimental to the emission efficiency of the gas G5. Namely, as illustrated by the double-dotted dashed line in FIG. 9, for example, if a similar opening area to that of the rear outer vent hole 94 were secured by a rear outer vent hole 94′ configured as a circular hole, there would be a possibility that the emission efficiency of gas G5′ emitted from the rear outer vent hole 94′ (see FIG. 10) would be reduced due to the rear outer vent hole 94′ being blocked by the door trim 28. However, the present exemplary embodiment enables this to be avoided.

### Fifth Exemplary Embodiment

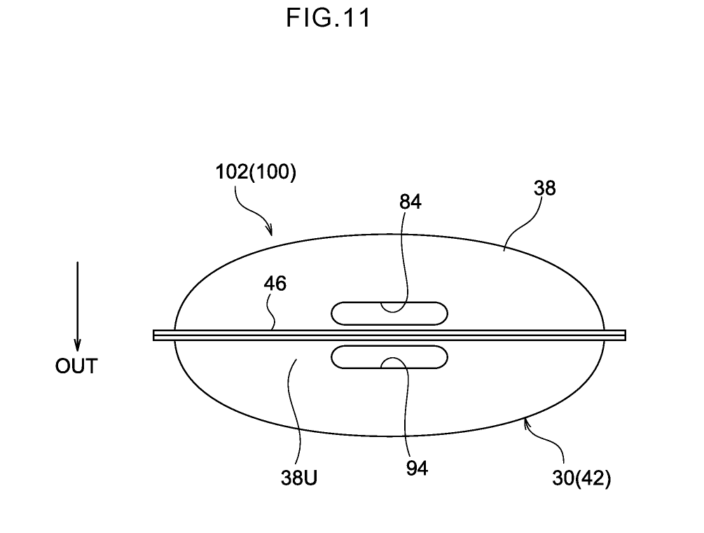

FIG. 11 is an end-on view corresponding to FIG. 6, illustrating an inflated and deployed state of a side airbag 102 in a vehicle side airbag device 100 according to a fifth exemplary embodiment of the present invention. In the side airbag 102, outer vent holes of the rear bag section 38 are configured by the rear outer vent hole 84 according to the third exemplary embodiment and the rear outer vent hole 94 according to the fourth exemplary embodiment. This enables gas emission efficiency from the rear bag section 38 to be further improved compared to the third exemplary embodiment and the fourth exemplary embodiment.

### Sixth Exemplary Embodiment

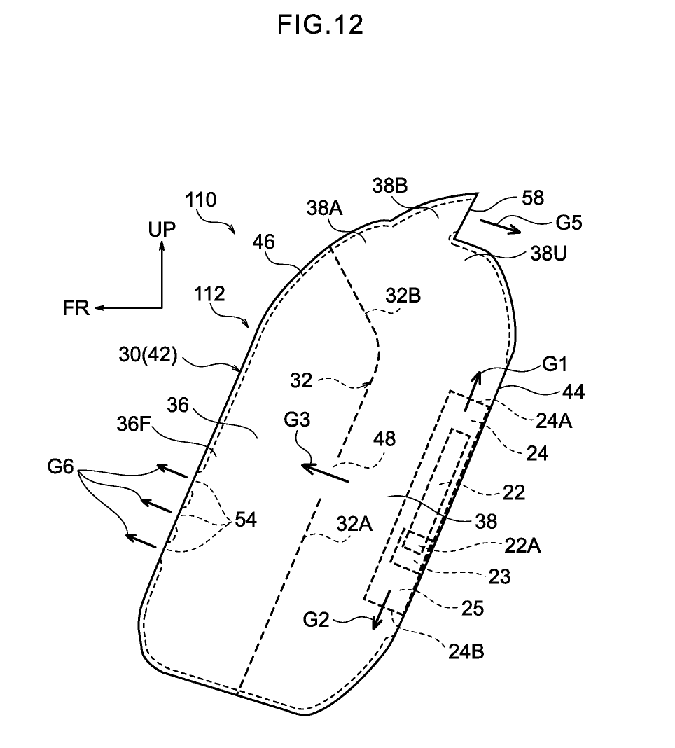

FIG. 12 is a side view corresponding to FIG. 3, illustrating an inflated and deployed state of a side airbag 112 in a vehicle side airbag device 110 according to a sixth exemplary embodiment of the present invention. In the side airbag 112, the lower bag section 40 according to the first exemplary embodiment is omitted, and the upright partitioning portion 32A, the front bag section 36, and the rear bag section 38 extend as far as a lower section of the side airbag 112. The lower outer vent hole 56 according to the first exemplary embodiment is also omitted from the side airbag 112. Other configuration is similar to that in the first exemplary embodiment. Although the present exemplary embodiment cannot obtain the restraint performance of the lumbar region L by the lower bag section 40, basically the same operation and advantageous effects as in the first exemplary embodiment are exhibited in other respects. The side airbag 112 also enables the configuration to be simplified.

### Seventh Exemplary Embodiment

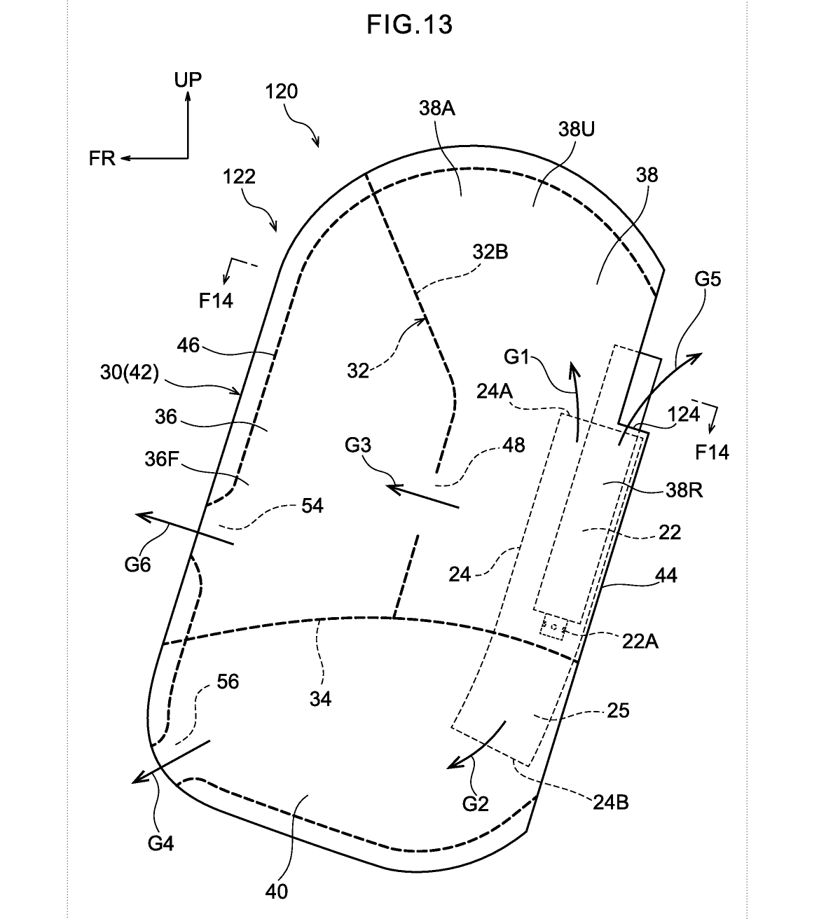

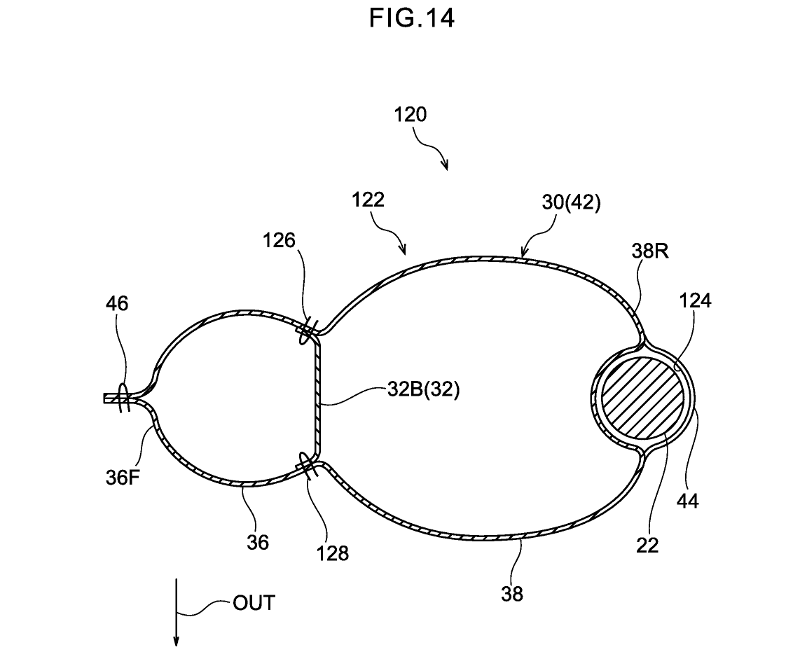

FIG. 13 is a side view corresponding to FIG. 3, illustrating an inflated and deployed state of a side airbag 122 in a vehicle side airbag device 120 according to a seventh exemplary embodiment of the present invention. FIG. 14 is a cross-section taken along line F14-F14 in FIG. 13. In the side airbag 122, only one front outer vent hole 54 is formed to a front edge portion 36F of a front bag section 36 and the deflector of the first exemplary embodiment is omitted. In the side airbag 122, the projection portion 38B and the rear outer vent hole 58 of the first exemplary embodiment are also omitted. In the side airbag 122, an inflator insertion port 124, as an outer vent hole, is formed to the rear edge portion 38R of the rear bag section 38. In FIG. 14, stitched portions 126 and 128 at where a front-rear partitioning section 32 is stitched to a base cloth 42 of a bag body 30 are illustrated.

The inflator insertion port 124 is formed by cutting off the middle part in a vertical direction of the rear end portion 38R of the rear bag section 38 like a step and is opened toward the vehicle upper side. An inflator 22 is inserted into the inflator insertion port 124. The upper end portion of the inflator 22 is located outside of the rear bag section 38 (outside of the side air bag 122) and the portion other than the upper end portion is located in the rear bag section 38. The inflator insertion port 124 is an insertion port for inserting the inflator 22 into the rear bag 38. Because the diameter of the inflator insertion port 124 is formed so that the diameter of the inflator insertion port 124 is larger than the diameter of the inflator 22, the inflator insertion port 124 works as an outer vent hole that evacuates gas supplied into the rear bag section 38 to outside of the side air bag 122. Other configuration of the side air bag 122 is similar to that in the side air bag 20 of the first exemplary embodiment.

According to this exemplary embodiment, the inflator insertion port 124 is formed to the rear end portion 38R of the rear bag section 38. Accordingly, blocking of the inflator insertion port 124 by a shoulder region S of an occupant P in a side-on collision in which the occupant P moves diagonally toward the front under inertia, and blocking of the inflator insertion port 124 due to interference with a side door 26 can be prevented or suppressed. Thereby, the internal pressure of the rear bag section 38 can be effectively reduced in the later restrain as with the first exemplary embodiment. Further, the inflator insertion port 124 that is an insertion port 124 where the inflator 22 is inserted into the rear bag 38 is also used as an outer vent hole. Accordingly, the side airbag 122 enables the configuration to be simplified. Moreover, gas G5 (see FIG. 13) emitted from the inflator insertion port 124 is ejected in a side section 14A of a seatback 14, thereby enabling the gas G5 to be prevented or suppressed from having a detrimental effect on the occupant P.

The present invention has been explained above using various exemplary embodiments; however, various modifications may be implemented to the present invention within a range not departing from the spirit thereof. The scope of rights of the present invention is not limited by the above exemplary embodiments.

As explained above, the vehicle side airbag device according to the present invention contributes to improving chest protection performance by the rear bag section.

1. A vehicle side airbag device comprising:
an inflator that is provided to a side section at a vehicle width direction outside of a seatback of a vehicle seat, and that operates to generate gas in a case in which a vehicle side-on collision is detected or predicted; and
an airbag in which gas from the inflator housed inside a rear bag section is supplied into a front bag section through an inner vent hole, the front and rear bag sections inflate and deploy, the front bag section restrains at least a front portion of the chest of an occupant, the rear bag section restrains at least a shoulder region and a rear portion of the chest of the occupant, and an outer vent hole for emitting gas inside the rear bag section to the outside is formed to an upper edge portion or a rear edge portion of the rear bag section.

2. The vehicle side airbag device of claim 1, wherein
the outer vent hole is formed to the upper edge portion of the rear bag section, faces a vehicle rear side in an inflated and deployed state of the airbag and is formed so as to be offset to the vehicle width direction outside of the seatback.

3. The vehicle side airbag device of claim 2, wherein:
a projection portion that projects toward a vehicle upper side in the inflated and deployed state is formed to the upper edge portion of the rear bag section; and
the outer vent hole is formed to a rear edge portion of the projection portion.

4. The vehicle side airbag device of claim 3, wherein the projection portion is formed in a substantially triangular shape in seat side view, such that a projection amount toward the vehicle upper side increases on progression toward the vehicle rear side.

5. The vehicle side airbag device of claim 1, wherein
the outer vent hole is formed to the upper edge of the rear bag section, and is configured by an unstitched portion formed by partially omitting an outer peripheral stitch section at which outer peripheral edge portions of a base cloth of the airbag are stitched together, or by an elongated hole formed running along the outer peripheral stitch section.

6. The vehicle side airbag device of claim 5, wherein
in the inflated and deployed state, the elongated hole is positioned at the vehicle width direction inside or the vehicle width direction outside of the outer peripheral stitch section.

7. The vehicle side airbag device of claim 1, wherein
the outer vent hole is formed to the rear edge portion of the rear bag section, and is opened toward a vehicle upper side, and the inflator is inserted into the outer vent hole.

8. The vehicle side airbag device of claim 1, wherein:
the airbag includes a lower bag section that is supplied with gas from the inflator and that inflates and that deploys below the front bag section and the rear bag section, and that restrains the lumbar region of the occupant;
a front outer vent hole is formed to the front bag section; and
a lower outer vent hole is formed to the lower bag section.

9. The vehicle side airbag device of claim 8, wherein
an opening area of the outer vent hole is the same as or larger than an opening area of the lower outer vent hole.

10. The vehicle side airbag device of claim 9, wherein
a plurality of the front outer vent holes are formed, and the opening area of the outer vent hole is smaller than a sum total of the opening areas of the plurality of front outer vent holes; and
the sum total of the opening areas of the plurality of front outer vent holes is smaller than an opening area of the inner vent hole.
